(19) United States
(12) Patent Application Publication
(10) Pub. No.: US 2002/0186475 A1
(43) Pub. Date: Dec. 12, 2002

(54) Optical system for scanner

(76) Inventors: Yin-Chun Huang, Hsinchu (TW); Chih-Wen Huang, Hsinchu (TW)

Correspondence Address: J.C. Patents, Inc., Suite 114, 1340 Reynolds Ave., Irvine, CA, 92614, US

(21) Appl. No.: 09/878,623

(22) Filed: Jun. 11, 2001

(51) Int. Cl. G02B 27/10

(52) U.S. Cl. 359/618

(57) ABSTRACT

An optical system inside a scanner for scanning a document. The optical system has a carrier box, a light source, a set of light reflecting mirrors, a circuit board, a converging mirror and an optical sensor. The carrier box has a hollow interior and a receiving slot in the upper surface thereof. The light source is fixed outside the carrier box such that light emitted from a lamp and reflected back from a document is able to pass through the receiving slot into the carrier box. The set of reflecting mirrors inside the carrier box reflects the light beam towards the converging lens and focuses upon the optical sensor. The optical sensor converts intensity of the light beam into electrical signals. Image distance between the converging lens and the optical sensor are adjusted before positioning the lens and sensor on the circuit board. The circuit board is placed on a sliding structure inside the carrier box so that object distance between the converging lens and document surface can be adjusted by sliding the circuit board to obtain an optimal image resolution.

### BACKGROUND OF THE INVENTION

1. Field of Invention

The present invention relates to an optical system. More particularly, the present invention relates to an optical system for scanning a document on a scanner.

2. Description of Related Art

Following the rapid increase in processing power of a computer, worldwide linking of the Internet and advancement of multimedia technologies, the scanner has become an indispensable peripheral device for a personal computer system. In general, a platform-type scanner includes an optical system and a driving system. Utilizing the driving system, an optical system inside a chassis is driven so that an optical sensor of the optical system may sequentially take in a batch of data from one portion of the document at a time. Image data is simultaneously converted into electrical signals for further processing. The optical sensor, for example, can be a charge-coupled device (CCD). In practice, an optical system is not limited to the application inside a scanner. Other devices including a photocopier and a fax machine may also employ such an optical system.

In general, an optical system includes at least a light source, a reflecting mirror and an optical sensor. Depending on the freedom to move, an optical system may be further divided into two major types of structural designs. One type of optical system utilizes a movable reflecting mirror to reflect light to a fixed optical sensor. In other words, the reflecting mirror and the optical sensor do not move synchronously. In a second type of optical system, the reflecting mirror and the optical sensor are housed within a carrier platform. To scan a document, the reflecting mirror and the optical sensor move together synchronously. This invention is related to the structural design of an optical system having both the reflecting mirror and the optical sensor moving synchronously together.

FIG. 1 is a schematic cross-sectional view of a conventional optical system. AS shown in FIG. 1, the optical system 100 includes a carrier box 110, a light source 120, a reflecting mirror 130, a converging lens 140 and an optical sensor 150. The optical system 100 is set up such that horizontal linear movement in a direction parallel to a scan document 10 is possible. Light emitted from the light source 120 is focused by a concave mirror 122 to form a beam 124. The beam 124 targets the document 10 and a portion of the light is reflected from the document surface. The reflected beam 124 passes through a receiving slot 112. After passing through a set of three reflecting mirrors 130, the reflected beam 124 is refracted by the converging lens 140 and ends up in the optical sensor 150. The receiving slot passes right through the upper wall of the carrier box 110. The optical sensor 150 is attached and electrically connected to a circuit board 152.

Conventionally, the resolution of an image on the optical system 100 is adjusted manually. After fixing the position of the set of reflecting mirrors 130, the converging lens 140 and the optical sensor 150 must be moved to suitable locations simultaneously so that the optical system can have the optimal image resolution. However, in manual adjustment of the optical system 100, relative position of both the converging lens 140 and the optical sensor 150 must be considered. Since the degree of difficulties for this type of adjustment is high, a longer time is required to adjust the optical system 100 or else adjustment accuracy has to be compromised.

### SUMMARY OF THE INVENTION

Accordingly, one object of the present invention is to provide an optical system for a scanner. The optical system employs a new design that uses a corresponding set of steps for adjustment so that complexity of the system is reduced and adjustment time is shortened. In addition, adjustment precision in increased and cost of producing the optical system is reduced.

To achieve these and other advantages and in accordance with the purpose of the invention, as embodied and broadly described herein, the invention provides an optical system inside a scanner suitable for scanning a document. The optical system includes a carrier box, a light source, a set of light reflecting mirrors, a circuit board, a converging mirror and an optical sensor. The carrier box has a hollow interior having a receiving slot at the upper surface. The light source is fixed outside the carrier box. The light source is positioned such that light emitted from a lamp and reflected back from a document to produce a first light beam is able to pass through the receiving slot into the carrier box. The set of reflecting mirrors includes at least a reflecting mirror installed inside the carrier box for deflecting the first light beam and outputting a second light beam. The circuit board is also installed inside the carrier box on a sliding structure so that the circuit board is capable of linear motion along the sliding structure. The sliding structure is linked to the interior walls of the carrier box. Linear movement of the circuit board along the sliding structure is in a direction parallel to the second light beam. The converging lens is mounted on the circuit board for refracting the second light beam into a third light beam. The optical sensor is also mounted on the circuit board at a position suitable for receiving the third light beam. The optical sensor converts intensity of the third light beam into electrical signals.

This invention also provides an alternative optical system inside a scanner suitable for scanning a document. The optical system includes a carrier box, a light source, a set of reflecting mirrors, a flat plate, a converging lens and a sensor. The carrier box has a hollow interior having a receiving slot at the upper surface. The light source is fixed outside the carrier box. The light source is positioned in such a way that a first light beam emitted from a lamp and reflected back from a document is able to pass through the receiving slot into the carrier box. The set of reflecting mirrors includes at least a reflecting mirror installed inside the carrier box for reflecting each first light beam to produce a second light beam. The flat plate is installed inside the carrier box on a sliding structure so that the flat plate is capable of sliding along the sliding structure. The sliding structure is linked to the interior walls of the carrier box. Linear movement of flat plate along the sliding structure is in a direction parallel to the second light beam. The converging lens is mounted on the flat plate for refracting the second light beam and producing a third light beam. The optical sensor is also mounted on the flat plate at a position suitable for receiving the third light beam. The optical sensor converts intensity of the third light beam into electrical signals.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 is a schematic cross-sectional view of a conventional optical system;

FIG. 2 is a schematic cross-sectional view of an optical system according to this invention;

FIG. 3 is a schematic side view of a converging lens, an optical sensor and a circuit board of the optical system shown in FIG. 2;

FIG. 4 is a perspective view of the converging lens, the optical sensor and the circuit board of the optical system as shown in FIG. 3;

FIG. 5 is a schematic cross-sectional view of a sliding structure of the optical system shown in FIG. 2;

FIG. 6 is a perspective view of an elastic stand according to this invention;

FIG. 7 is a diagram showing the relationship between the elastic stand shown in FIG. 6 and the converging lens shown in FIG. 2; and

FIG. 8 is a schematic side view showing the relationship between a flat plate, the converging lens and the optical sensor inside an optical system according to this invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

FIG. 2 is a schematic cross-sectional view of an optical system according to this invention. The optical system 200 includes a carrier box 210, a light source 220, a set of reflecting mirrors 230 and an optical sensor 250. The optical system 200 is capable of moving in a horizontal direction parallel to a document 20. The light source 220 is a lamp, for example. Light emitted from the lamp is focused by a concave mirror 222 to produce a light beam 224. The light beam 224 impinges upon the document 20 and reflects into the carrier box 210 via a receiving slot 212. After three consecutive reflections by the reflecting mirrors 230, the light beam 224 is brought to the converging lens 240. The converging lens 240 refracts the light beam before sending to the optical sensor 250. The optical sensor 250 converts intensity of the light beam 224 into electrical signals. The receiving slot 212 is a slit that passes through the upper wall of the carrier box 210 and the optical sensor is a charge-coupled device (CCD), for example.

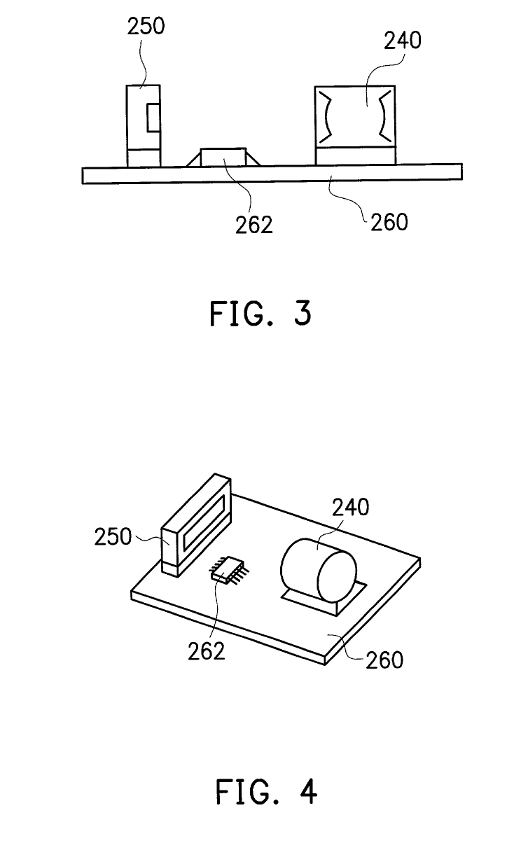

FIGS. 3 and 4 are a schematic side view and a perspective view of a converging lens 240, an optical sensor 250 and a circuit board 260 of the optical system shown in FIG. 2. As shown in FIGS. 3 and 4, the optical sensor 250 is mounted on and electrically connected to the circuit board 260. The converging lens 240 is also mounted on the circuit board 260 and positioned at a location such that the refracted light rays after passing through the converging lens 240 fall on the optical sensor 250. An image-processing device 262 may also be installed on the circuit board 260 for an increased boosting of image signal transformation capacity or providing additional functions.

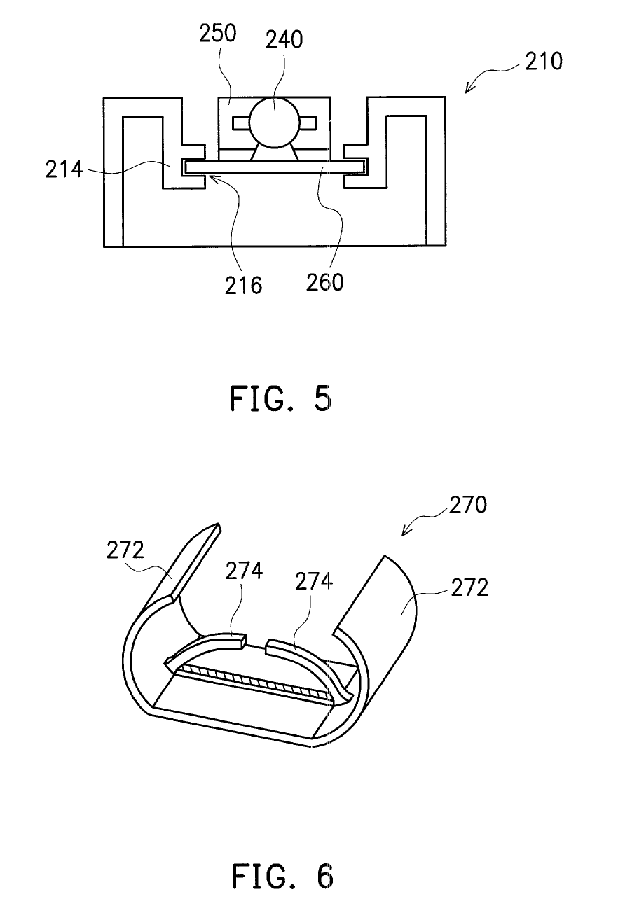

FIG. 5 is a schematic cross-sectional view of a sliding structure 214 of the optical system shown in FIG. 2. As shown in FIGS. 2 and 5, the sliding structure 214 is a protruding section from the carrier box 210 or an independently produced structure connected to the interior walls of the carrier box 210. The ends of the sliding structure 214 form a pair of rails 216 capable of accommodating the sides of the circuit board 260 so that the circuit board 260 can slide horizontally, guided by the rails 216 as shown in FIG. 2.

As shown in FIGS. 3 and 4, relative distance of separation between the converging lens 240 and the optical sensor 250 can be determined using the standard lens formula: 1/p+1/q=1/f, where p is object distance, q image distance and f is the focal length of a lens. Because identical converging lens 240 has an identical focal length f, the value of f is a fixed value. The only variables in the lens equation are the object distance and the image distance. In the optical system 200 of this invention, the image distance q is adjusted before the object distance p. To adjust the parameters p and q, the converging lens 240, the optical sensor 250 and the circuit board 260 are placed on a calibration fixture. An ideal object distance p is determined. The ideal object distance is roughly equal to the overall distance starting from the document via various reflecting mirrors 230 to the converging lens 240. Utilizing test charts, distance between the converging lens 240 and the optical sensor 250 is set. Finally, the converging lens 240 and the optical sensor 250 on the circuit board 250 are fixed, thereby completing the adjustment of the image distance q.

After adjusting the image distance q, the circuit board 260 is slipped into the guiding rails 216 so that the converging lens 240 and the optical sensor 250 on the circuit board 260 is able to slide horizontally as shown in FIG. 2 (or perpendicularly for FIG. 5). The circuit board 260 moves in a direction parallel to light arriving at the converging lens 240. By moving the circuit board 260 linearly, object distance p required by the optical system 200 can be obtained. Thereafter, the circuit board 260 is also fixed. Finally, after further adjustment of other related factors, the positioning of various components in the optical system 200 is completed.

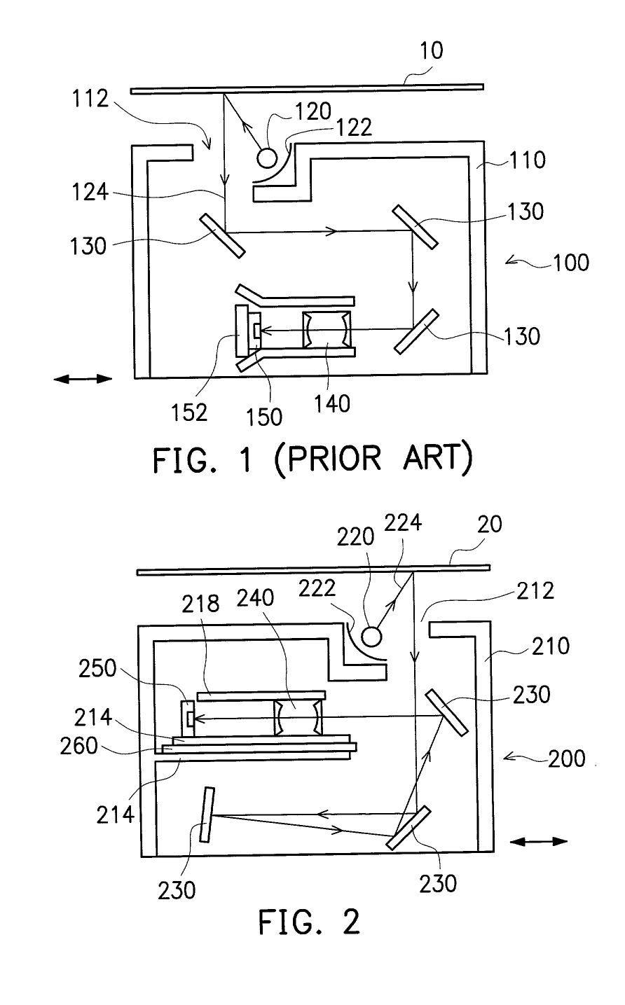

In a conventional optical system as shown in FIG. 1, the converging lens 140 and the optical sensor 150 are independent components. Hence, to obtain an optimal image resolution by manual adjustment, two distance parameters (object distance and image distance) must be found simultaneously. In other words, optimal location for both the converging lens 140 and the optical sensor 150 must be found at the same time. Hence, progress of the manual adjustment is slow. However, in this invention, an ideal object distance is used to find an image distance. That is, either the converging lens 240 or the optical sensor 250 is fixed to find an optimal resolution for the other one. The adjusted converging lens 240, the optical sensor 250 and the circuit board 260 are placed inside the carrier box 210. Through the rails 216 of the sliding structure 214, the circuit board 260 carrying the converging lens 240 and the optical sensor 250 can be moved to a suitable object distance for obtaining an optimal resolution. The circuit board 260 is fixed on the sliding structure 214 to complete optical system 200 adjustment.

As shown in FIG. 4, the converging lens 240 has a cylindrical outer perimeter. Hence, positioning the outer perimeter of the converging lens 240 is difficult. To resolve this problem, this invention also provides an elastic stand 270 for holding and fixing the position of the converging lens 240. FIG. 6 is a perspective view of the elastic stand 270 according to this invention. FIG. 7 is a diagram showing the relationship between the elastic stand shown in FIG. 6 and the converging lens 240 shown in FIG. 2. The elastic stand 270 is a component between the converging lens 240 and the circuit board 260. The elastic stand 270 has a clamping section 272 and a protrusion section 274. The bottom of the elastic stand 270 is attached to the circuit board 260. The clamping section 272 grips the perimeter on opposite sides of the converging lens 240 elastically. The bottom perimeter of the converging lens 240 is pushed against the protruding section 274 in a direction 276 shown in FIG. 7. The elastic stand 270 can be made from a plastic or a metallic material. If the elastic stand 270 is made from plastic, the elastic stand 270 can be manufactured by injection. If the elastic stand 270 is made from metal, the protruding section 272 can be formed by punching the central region of a metallic plate before bending the sides of the metallic plate to form the clamping section 272. The protruding section 274 is not limited to a pair of curved linear strips as featured in FIG. 6. Other shapes are also possible. Moreover, one or more pairs of protruding sections 274 for increasing the stabilizing forces against the bottom perimeter of the converging lens 240 may be designed.

As shown in FIGS. 2 and 7, the upper perimeter of the converging lens 240 has a positioning structure 218. The positioning structure 218 is fixed on the interior walls of the carrier box 210 or extended from the interior walls of the carrier box 210. The positioning structure 218 also provides a reference surface 219 for the converging lens 240. The reference surface 219 can be a flat surface or an arched surface that matches the external perimeter of the converging lens 240. When the protruding section 274 of the elastic stand 270 is propped against the converging lens 240, the upper perimeter of the converging lens 240 presses against the reference surface 219 of the positioning structure 218. By matching the elastic stand 270 and the positioning structure 218, the converging lens 240 is precisely located. Ultimately, the light beam 224 entering the converging lens 240 can follow a more accurate path leading to a higher image resolution.

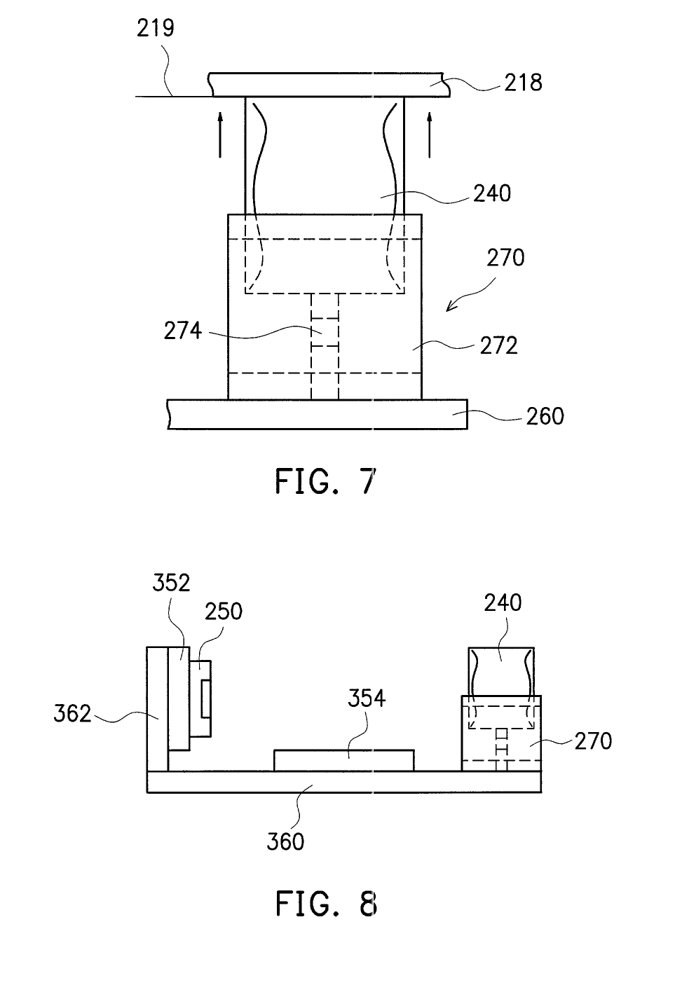

FIG. 8 is a schematic side view showing the relationship between a flat plate 360, the converging lens 240 and the optical sensor 250 inside an optical system 200 according to this invention. As shown in FIG. 8, the flat plate 360 replaces the circuit board 260 in FIG. 3 for holding the converging lens 240 and the optical sensor 250. The flat plate 360 can be made from a plastic or a metallic material. The elastic stand 270 gripping the converging lens 240 is fixed at a suitable location on the flat plate 360. The elastic stand 270 and the flat plate 360 can be manufactured as an integrated component. The optical sensor 250 is positioned at a location that corresponds to the outcoming beam from the converging lens 240. The optical sensor 250 is attached to a plate 362 erected perpendicular to the flat plate 360. However, the vertical plate 362 and the flat plate 360 may be formed together as an integrated component. In other words, the elastic stand 270, the vertical plate 362 and the flat plate 360 may be manufactured as a single piece.

Similarly, the optical sensor 250 has a circuit board 352 between the optical sensor and the vertical plate 362. The optical sensor 250 and the circuit board 352 are electrically connected together. Furthermore, a plurality of image processors 262 similar to the one shown in FIGS. 3 and 4 may also be formed on the circuit board 352 for boosting processing power and adding functions.

In conclusion, principal advantages of the optical system include:

1. The integration of the converging lens and the optical sensor together on a circuit board in the optical system simplifies assembling and speeds up optical system adjustment.

2. Distance between the converging lens and the optical sensor on a circuit board is pre-adjusted prior to adjusting the image distance between the converging lens and the document. Hence, optical system adjustment is simplified and adjusting time is shortened.

3. The circuit board of the optical system is mounted on a sliding structure capable of linear motion so that distance between the converging lens and document surface can be adjusted. Therefore, manual adjustment of distance can be completed much more quickly.

4. The converging lens in the optical system is fixed in position by an elastic stand and the reference surface of a positioning structure. Hence, light impinging upon the converging lens follows a precise path resulting in a higher overall resolution.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An optical system inside a scanner for scanning a document, comprising:
a carrier box having a hollow interior and a receiving slot, wherein the receiving slot passes through an upper wall of the carrier box;
a light source located outside the carrier box capable of emitting a first beam of light towards the document to produce a reflected beam from the document, wherein the reflected light beam passes into the carrier box via the receiving slot;
a set of reflecting mirrors having at least a reflecting mirror, wherein the set of reflecting mirrors is installed inside the carrier box for receiving the first light beam and outputting a second light beam;
a circuit board mounted on a sliding structure inside the carrier box, wherein the circuit board moves linearly, the sliding structure is connected to interior walls of the carrier box, and the circuit board moves in a direction identical to a traveling direction of the second light beam;
a converging lens mounted on the circuit board for refracting the second light beam and outputting a third light beam; and
an optical sensor mounted on the circuit board for receiving the third light beam and converting an intensity of the third light beam into electrical signals.

2. The optical system of claim 1, wherein the light source includes a tubular light source.

3. The optical system of claim 1, wherein the optical sensor includes a charge-coupled device.

4. The optical system of claim 1, wherein the circuit board further includes at least an imaging processor.

5. The optical system of claim 1, wherein the optical sensor and the circuit board are electrically connected together.

6. The optical system of claim 1, wherein the sliding structure is a pair of extensions from the interior walls of the carrier box and the pair of extensions form a pair of guiding rails for holding sides of the circuit board.

7. The optical system of claim 1, wherein an upper perimeter of the converging lens further includes a positioning structure connected to interior walls of the carrier box and has a reference surface facing the converging lens.

8. The optical system of claim 7, wherein the positioning structure is an extension from the interior wall of the carrier box.

9. The optical system of claim 7, wherein the reference surface is either a flat or an arched surface.

10. The optical system of claim 7, wherein the converging lens is mounted on the circuit board via an elastic stand, a bottom of the elastic stand is attached to the circuit board, the elastic stand has a clamping section and a protruding section, the clamping section grips opposite perimeters of the converging lens elastically, the protruding section is propped against a bottom perimeter of the converging lens, and the upper perimeter of the converging lens leans against the reference surface.

11. The optical system of claim 10, wherein the elastic stand is made from either a plastic or a metallic material.

12. An optical system inside a scanner for scanning a document, comprising:
a carrier box having a hollow interior and a receiving slot, wherein the receiving slot passes through an upper wall of the carrier box;
a light source located outside the carrier box capable of emitting a first beam of light towards the document to produce a reflected beam from the document, wherein the reflected light beam passes into the carrier box via the receiving slot;
a set of reflecting mirrors having at least a reflecting mirror, wherein the set of reflecting mirrors is installed inside the carrier box for receiving the first light beam and outputting a second light beam even;
a flat plate mounted on a sliding structure inside the carrier box, wherein the circuit board moves linearly, the sliding structure is connected to interior walls of the carrier box, and the circuit board moves in a direction identical to the traveling direction of the second light beam;
a converging lens mounted on the flat plate for refracting the second light beam and outputting a third light beam; and
an optical sensor mounted on the flat plate for receiving the third light beam and converting intensity of the third light beam into electrical signals.

13. The optical system of claim 12, wherein the optical sensor is attached to the face of a vertical plate mounted perpendicular to the flat plate and is positioned to collect light from the converging lens.

14. The optical system of claim 13, wherein the vertical plate and the flat plate are formed together as a single component.

15. The optical system of claim 12, wherein the light source includes a tubular light source.

16. The optical system of claim 12, wherein the optical sensor includes a charge-coupled device.

17. The optical system of claim 12, wherein the sliding structure is a pair of extensions from the interior walls of the carrier box and form a pair of guiding rails for holding sides of the flat plate.

18. The optical system of claim 12, wherein an upper perimeter of the converging lens further includes a positioning structure connected to the interior walls of the carrier box and has a reference surface facing the converging lens.

19. The optical system of claim 18, wherein the positioning structure is an extension from the interior wall of the carrier box.

20. The optical system of claim 18, wherein the reference surface is either a flat or arched surface.

21. The optical system of claim 18, wherein the converging lens is mounted on the circuit board via an elastic stand, a bottom of the elastic stand is attached to the flat plate, the elastic stand has a clamping section and a protruding section, the clamping section grips opposite perimeters of the converging lens elastically and the protruding section is propped against a bottom perimeter of the converging lens and the upper perimeter of the converging lens leans against the reference surface.

22. The optical system of claim 21, wherein the elastic stand and the flat plate are formed together as a single component.

23. The optical system of clam 13, wherein the elastic stand, the vertical plate and the flat plate are formed together as a single component.

24. The optical system of claim 12, wherein the flat plate is made from either a plastic material or a metallic material.

25. The optical system of claim 21, wherein the elastic stand is made from either a plastic material or a metallic material.

26. The optical system of claim 12, wherein the optical sensor further includes a circuit board between the optical sensor and the vertical plate for holding and electrically connecting with the optical sensor.

27. The optical system of claim 26, wherein the circuit board has at least an image processor mounted thereon.

28. The optical system of claim 12, wherein the optical system further includes a circuit board mounted on a surface of the flat plate.

29. The optical system of claim 28, wherein the optical sensor and the circuit board are electrically connected.

30. The optical system of claim 28, wherein the circuit board further has at least an image processor mounted thereon.
